(19) United States
(12) Patent Application Publication
(10) Pub. No.: US 2011/0192244 A1
(43) Pub. Date: Aug. 11, 2011

(54) DRIVE DEVICE

(75) Inventors: Stephan Mayer, Achern (DE); Jean-Marc Ritt, Strasbourg (FR)

(73) Assignee: ROBERT BOSCH GMBH, Stuttgart (DE)

(21) Appl. No.: 13/120,806

(22) PCT Filed: Sep. 3, 2009
(86) PCT No.: PCT/EP2009/061401

§ 371 Date: Mar. 24, 2011

(30) Foreign Application Priority Data
Oct. 9, 2008 (DE) 102008042707.1

(51) Int. Cl. F16H 21/44

(52) U.S. Cl. 74/103

(57) ABSTRACT

The invention relates to a drive device for a windshield wiper device for moving an output shaft (32), having an input shaft (12) which can be driven through a motor (10) and which is connected to a linear motion element (20) in a rotationally fixed manner, wherein the linear motion element (20) is connected to the output shaft (32) through exactly one coupler (24) and exactly one rocker (28), wherein the coupler (24) is supported between the linear motion element (20) and the rocker (28) in an articulated manner and the rocker (28) is connected to the output shaft (32) in a rotationally fixed manner. In said manner, large forces can be transmitted using self-locking in a small design.

### BACKGROUND OF THE INVENTION

The invention relates to a drive device for a windshield wiper device, and to a windshield wiper device for a motor vehicle.

In vehicles having reverse rotation wiper systems and large windshields, use is generally made of two-motor wiper systems, wherein essentially reversing motors are used with a conventional linkage between an oscillating motor and an output shaft. For example, DE 10 2006 042 322 A1 discloses a windshield wiper system with a windshield wiper drive and a transmission arrangement for driving a wiper shaft, in which an oscillating rotational movement is generated in the wiper shaft by a worm being provided as a push rod which is connected via an eccentric and articulated connection to a worm wheel. A drawback here is that the bulky worm wheel and the reciprocating and oscillating movement produced by the push rod require a considerable amount of installation space, thus making flexible use in different motor vehicle models difficult.

### SUMMARY OF THE INVENTION

It is the object of the invention to provide a drive device for a windshield wiper, and a windshield wiper device for a motor vehicle, having a compact construction and being usable universally.

The object is achieved according to the invention by a drive device for a windshield wiper device and by a windshield wiper device for a motor vehicle.

The drive device according to the invention for a windshield wiper device for moving an output shaft, with the aid of which in particular a windshield wiper device of a motor vehicle can be driven, has a drive shaft which can be driven via a motor and is connected to a linear movement element in a rotationally fixed manner. According to the invention, the linear movement element is connected to the output shaft via precisely one connecting rod and precisely one oscillating crank, the connecting rod, in turn, being mounted in an articulated manner between the linear movement element and the oscillating crank, and the oscillating crank being connected to the output shaft in a rotationally fixed manner. In this case, the drive shaft can preferably be designed as a spindle or worm thread and the linear movement element as a spindle nut, and therefore, by means of the use of the linear guide element, the rotational movement of the drive shaft can be converted into a linear movement and, by means of the oscillating crank and connecting rod, can be converted back into a rotational movement at the drive shaft. Furthermore, this enables the axial offset to be reduced with the space required for the drive device.

In a particularly preferred embodiment, the drive shaft can be designed as a worm in only a defined sub region, and therefore the shaft length of the drive shaft can be selected independently of the shaft length of the output shaft and both a short and a long output shaft length can be realized. The travel of the linear movement element can advantageously be fixed individually, and therefore the space required by the drive device can be matched to the space available in the engine and to the number of wiper arms.

The length of the connecting rod and/or the length of the oscillating crank and/or the pitch of the drive shaft can preferably be fixed variably, and therefore the transmission ratio of the drive device can be matched to the use thereof and correspondingly optimized. It is thereby possible to provide a drive device with an elongate structural form and variable component dimensions, which drive device is efficient and can be used flexibly in the motor vehicle construction spaces.

The drive device is advantageously self-locking in the inoperative state. This is desirable, since current is not supplied to the motor in the inoperative state and therefore, without adequate self-locking, the drive rod would be freely rotatable, and the risk would exist that the drive rod could be set into rotation by the introduction of a torque, for example by relative wind, and, as a result, the wiper arm could be moved into the field of view of the vehicle driver. The wiping angle of the wiper arm can be adjusted individually, with adjustments being possible both via the output shaft in the form of an angle transmitter and via the drive shaft in the form of a linear transmitter.

In a particularly advantageous manner, a defined sub region of the drive shaft can be interchangeable, wherein the defined sub region of the drive shaft can be designed as a spindle or worm and, depending on the embodiment, has different diameters and/or lengths and/or threads or thread pitches, and therefore the drive device or the respective drive shaft of the drive device can be matched variably to the predefined use, for example to a motor vehicle.

The motor can preferably be configured as a reversing motor which can be regulated via an electronic system such that the motor can be controlled in different rotational directions corresponding to the oscillating movement of the wiper blade. In a preferred embodiment, the drive device can have a sensor device for monitoring and controlling the windshield wiper device. In this case, an electronic control system can be provided which, for example when the motor is switched on, detects the input of sensor signals in order to be able to correspondingly switch over the direction of rotation of the motor. In this manner, the linear movement of the linear movement element and/or the radial movement of the output element can be determined and, depending on the embodiment of the motor vehicle, can be correspondingly adjusted or adapted such that the wiping angle and the wiper speed or the parking position of the wiper arm can be regulated individually via the sensor device and the electronic control system and, by means of individual matching of the drive shaft, the size of the transmission can therefore also be configured in a correspondingly flexible manner. Furthermore, it is conceivable that the wiping angle in the wiper region can be determined and adjusted variably with reference to the travel covered by the linear movement element or to the angular movement of the output element. With the aid of a sensor device of this type and/or by means of a reversing motor of this type, both the length of the wiper arm and the length of the output element can be adjusted variably and the range of action of the windshield wiper device can be expanded.

The drive device can advantageously be installed in the installation space in such a manner that the output shaft is protected and effects from the outside can be very substantially prevented.

The invention furthermore relates to a windshield wiper device with a drive device and to a motor vehicle with a windshield wiper device, wherein the output shaft is connected to at least one wiper arm in a rotationally fixed manner.

### BRIEF DESCRIPTION OF THE DRAWINGS

The invention is explained in more detail below using a preferred exemplary embodiment and with reference to the attached drawings. It should be noted here that the figures have merely a descriptive character and are not conceived to restrict the invention in any form.

In the drawings:

FIG. 1a shows a perspective schematic view of a drive device according to the invention in a starting position,

FIG. 1b shows a perspective, schematic view of a drive device according to the invention in a central position,

FIG. 1c shows a perspective, schematic view of a drive device according to the invention in a reversal position.

FIG. 2 shows a schematic view of a drive device according to the invention with a housing cover.

### DETAILED DESCRIPTION

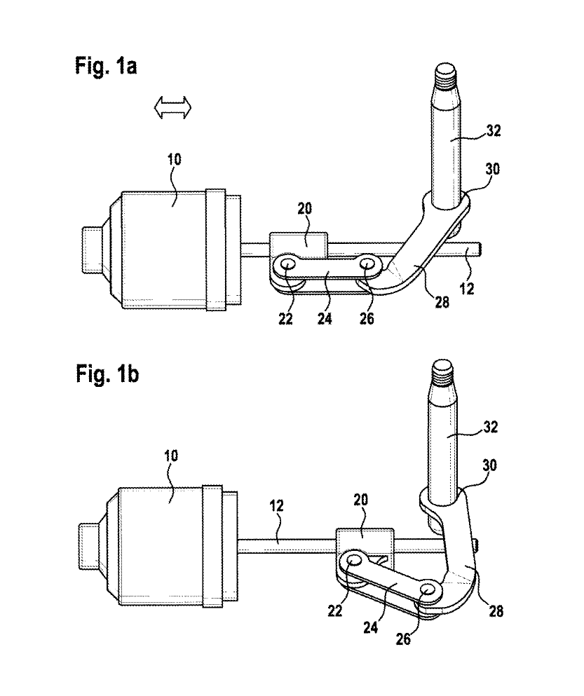

FIGS. 1a to 1c illustrate a drive device according to the invention for a windshield wiper device for moving an output shaft 32. In this case, a motor 10, preferably a reversing motor, drives a rotatably mounted drive shaft 12 which is preferably designed as a spindle or worm thread. The drive shaft 12 is connected to a linear movement element 20 in a rotationally fixed manner, and therefore a rotational movement of the drive shaft 12 can be converted into a linear movement of the linear movement element 20. The linear movement element 20 is connected via a first joint 22 to a coupling rod 24, wherein the coupling rod 24 is connected via a second joint 26 to an oscillating crank 28, and the oscillating crank 28 is connected via a hollow bore 30 to an output shaft 32 in a rotationally fixed manner. The linear movement element 20 is driven by the motor 10 via the drive shaft 12 and moves to and fro between the motor 10 and the output shaft 32 in a linear movement on the drive shaft 12 (FIG. 1a to FIG. 1c). In this case, the linear movement of the linear movement element 20 is converted via the articulated mounting of the coupling rod 24 into a rotational movement of the oscillating crank 28 such that the oscillating crank 28 can deliver said rotational movement via the output shaft 32, which is connected in a rotationally fixed manner, either directly or indirectly to at least one wiper arm (not illustrated).

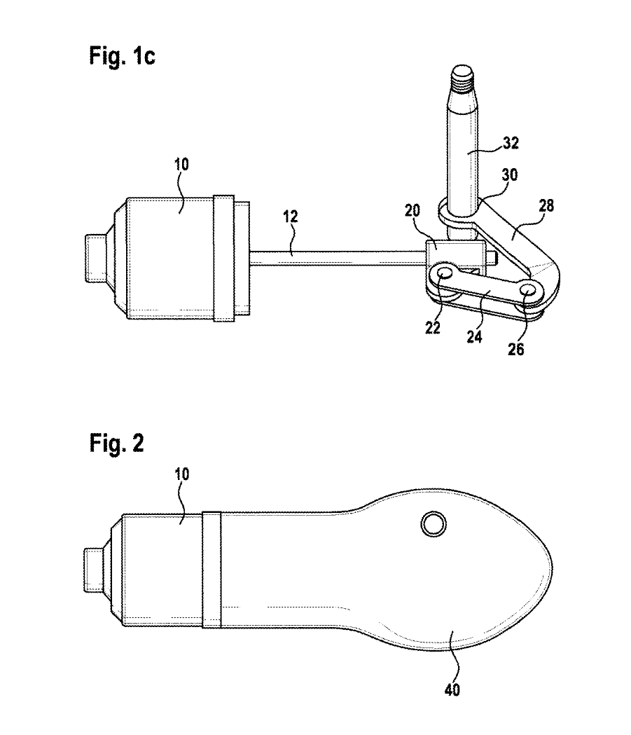

FIG. 2 shows the drive device according to the invention with a suitable housing cover 40.

The present invention furthermore relates to a windshield wiper device with a drive device and to a motor vehicle with a windshield wiper device, wherein the output shaft is connected to at least one wiper arm in a rotationally fixed manner.

1. A drive device for a windshield wiper device for moving an output shaft (32), the drive device comprising:
a drive shaft (12) which can be driven via a motor (10),
wherein the drive shaft (12) is connected to a linear movement element (20) in a rotationally fixed manner,
characterized in that the linear movement element (20) is connected to an output shaft (32) via precisely one coupling rod (24) and precisely one oscillating crank (28), the coupling rod (24) being mounted in an articulated manner between the linear movement element (20) and the oscillating crank (28), and the oscillating crank (28) being connected to the output shaft (32) in a rotationally fixed manner.

2. The drive device as claimed in claim 1, characterized in that the drive shaft (12) is designed as a worm only in a defined sub region.

3. The drive device as claimed in claim 2, characterized in that the defined sub region of the drive shaft (12) is interchangeable.

4. The drive device as claimed in claim 1, characterized in that the motor (10) is configured as a reversing motor.

5. The drive device as claimed in claim 1, characterized in that a sensor device is provided for monitoring and controlling the windshield wiper device.

6. The drive device as claimed in claim 1, characterized in that the output shaft (32) is connected to at least one wiper arm in a rotationally fixed manner.

7. The drive device of claim 1, wherein the drive device is used for a windshield wiper device of a motor vehicle.
